(19) United States
(12) Patent Application Publication
(10) Pub. No.: US 2009/0252568 A1
(43) Pub. Date: Oct. 8, 2009

(54) Automatic Securing Device for Cargo Containers

(76) Inventor: Gaston Morin, St-Gabriel de Brandon (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/419,972

(22) Filed: Apr. 7, 2009

Related U.S. Application Data
(60) Provisional application No. 61/042,775, filed on Apr. 7, 2008.

(51) Int. Cl. B60P 7/13; B60P 7/06

(52) U.S. Cl. 410/69

(57) ABSTRACT

The present invention provides a device for automatically engaging a cargo container on a platform or transporting vehicle. The device comprises a pair of hooks to vertically restrain the container and a pair of stop plates to laterally restrain the container. The hooks are normally in an engaged position and move downwardly to an unengaged position when a container engages one of the sides of the device. The hooks and stop plates recover their engaged position when the container is properly in place on the platform. A spring or other resilient means extending between the frame and the platform allows the hooks and stop plates to recover their engaged position when the container is on platform or transporting vehicle.

### CROSS-REFERENCE TO RELATED APPLICATIONS

The present patent application claims the benefits of priority of commonly assigned American Provisional Patent Application No. 61/042,775, entitled “AUTOMATIC CONTAINER SECURING DEVICE” and filed at the United States Patent and Trademark Office on Apr. 7, 2008.

### FIELD OF THE INVENTION

The present invention generally relates to a locking or securing mechanism for cargo containers transported on loading platform or a cargo transporting vehicle.

### BACKGROUND OF THE INVENTION

Locking mechanisms are used in the freight industry to secure or lock cargo such as containers or palettes in the lateral and/or vertical position on the surface of a loading platform of a cargo transporting vehicle.

When cargo and especially containers are transported to and from aircrafts, trucks, trailers and other carriers, they are often loaded onto a cargo transporting vehicles which is then moved to the desired location. Normal movement and vibration of the vehicle could result in possible loss of control, when allowed to move freely without restraint. Furthermore, when the containers are empty, they could be lifted up from the platform under the action of the wind or bumps. In order to counter this problem, a large number of locking structures have been devised which hold the pallets or containers in place so that they cannot move until the locks are disengaged by an operator.

A device to secure a container on a cargo transporting vehicle or car having a simple configuration with fewer parts with a higher resistance to outside conditions would have the advantage of being less expensive in comparison to a new cargo transporting vehicle.

### SUMMARY OF THE INVENTION

The aforesaid and other objectives of the present invention are realized by generally providing an automatic securing device for cargo containers to be used with a cargo transporting vehicle having a platform, the device comprising a support, the support being connected to the cargo transporting vehicle, a frame having a rotational axis, the frame being rotatably connected to the support, a pair of hooks rotatably connected to the support, the hooks adapted to restrain the container vertically, the hooks being displaceable between an engaged position and an unengaged position, the hooks being rotatably connected to the support; and a pair of stop plates substantially vertically connected to the frame, the stop plates adapted to laterally restrain the container, the stop plates being displaceable between an engaged position and an unengaged position, means to resiliently upwardly bias the hooks and the stop plates to their engaged positions; and means engageable with the container to cause the hooks and the stop plates to move downwardly to their unengaged position.

The present invention provides an automatic securing device for containers to be used with a cargo transporting vehicle having a platform, the device comprising a support, the support being connected to the cargo transporting vehicle, a frame and the pair of hooks to vertically restrain the container, the hooks having an engaged position and an unengaged position, the hooks being rotatably connected to the support, a the of plates to laterally restrain the container, the plates being connected to the frame and the stop plates having an engaged and an unengaged position, a pair of springs extending between the cargo transporting vehicle and the frame and a ramp part having an angle allowing the container to slide onto the platform when the container is pushed onto the cargo transporting vehicle, wherein the container pushes the ramp part downward compressing the guiding parts which compresses the springs therefore, causing the hooks and the ramp part to move from the engaged to the unengaged position.

The device of the present invention is used to restrain the movement of a container on a cargo transporting vehicle. When the device is in an engaged position, the pair of hooks are upwardly oriented and engage the edge of the container, if present. A pair of stop plates is moved above the level of the platform in the engaged position and limit the lateral movement of the container.

The ramp parts have a slope allowing the container to slide on the platform when the container is pushed thereon. When the container is pushed on the platform, the ramp part compresses the springs, causing the hooks and the stop plates to move from the engaged position to the unengaged position.

In a preferred embodiment, the frame comprises a pair of hook actuators, the hook actuators being in contact with the pair of hooks when the hooks are in the engaged position. When a hook actuator moves downward with the frame, nothing retains the hooks in their engaged position, thus the hooks will pivot downward towards the outside of the cargo transporting vehicle. To prevent the hooks from pivoting towards the inside of the transporting car, a limiting member limits the movement of the hook towards the inside direction. The hooks movement is also physically limited by the frame in the unengaged position.

Since the cargo transporting vehicle can be loaded from both sides, the device can be preferably actuated from both sides and the movement is transmitted to the other side of the device through the frame. Thus, both hooks and stop plates will engage the container simultaneously when the device gets to the engaged position.

In a preferred embodiment, the frame comprises a pair of retainers cooperating with the support or the transporting vehicle. The retainers are along an axis referred to as the rotational axis of the frame. The device can be disengaged by the user who simply has to apply pressure to one pedal of the device typically by stepping on it. By doing so, the frame rotates around the rotational axis of the frame and compresses the springs. The hook actuator moves downward and the hooks pivot downward toward the outside of the cargo transporting car, allowing the container located on the platform to be moved.

One of the advantages of the present invention is that the device may be retrofit in an existing transporting vehicle. The device is easy to install and may be easily removed to be repaired. The device is easily installed on existing cargo transporting cars and platforms and may easily be removed for repairs.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a perspective view of the automatic securing device for container with the hooks and the stop plates in their engaged position.

FIG. 2a is partial perspective view of the automatic securing device for container with the hooks and the stop plates in their engaged position, as installed on a platform.

FIG. 2b is another partial perspective view of the automatic securing device for container with the hooks and the stop plates in their engaged position, as installed on a platform.

FIG. 3 is a side view of the automatic securing device for container with the hooks and the stop plates in their engaged position.

FIG. 4 is a top view of the automatic securing device for container with the hooks and the stop plates in their engaged position.

FIG. 5 is a perspective view of the automatic securing device for container with the hooks and the stop plates in their unengaged position.

FIG. 6 is a side view of the automatic securing device for container with the hooks and the stop plates in their unengaged position.

FIG. 7a is partial perspective view of the automatic securing device for container with the hooks and the stop plates in their unengaged position, as installed on a platform.

FIG. 7b is another partial perspective view of the automatic securing device for container with the hooks and the stop plates in their unengaged position, as installed on a platform.

FIG. 8 is a top view of the automatic securing device for container with the hooks and the stop plates in their unengaged position.

FIG. 9 is a perspective view of the automatic securing device for container as installed on a turntable ring of a cargo transporting vehicle.

### DETAILED DESCRIPTION OF THE PREFERRED EMBODIMENT

A novel automatic securing device for container will be described hereinafter. Although the invention is described in terms of specific illustrative embodiment(s), it is to be understood that the embodiment(s) described herein are by way of example only and that the scope of the invention is not intended to be limited thereby.

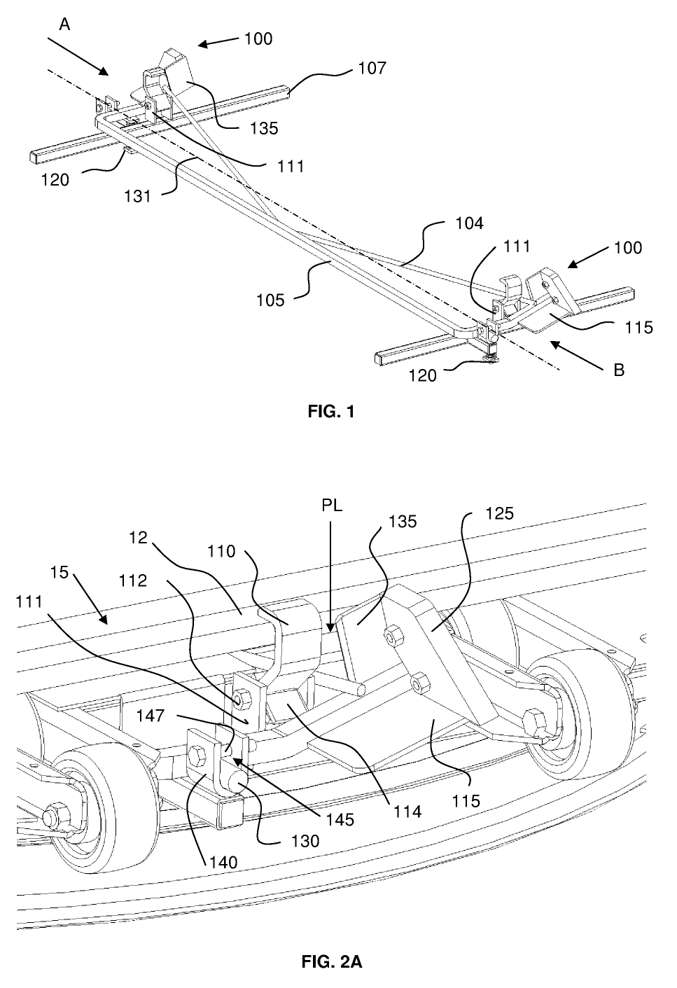

As shown in FIG. 1, the automatic securing device for container 100 of the present invention comprises a u-bar or frame 105, a pair of hooks 110, a pair of stop plates 135, a pair of pedals 115 and a pair of resilient means 120. It is to be noted that the cargo transporting vehicle is only partially shown since it is well known in the art. The device comprises also a pair of support portions 107 to be connected to the cargo transporting vehicle, the supports comprising two elongated portions perpendicularly disposed. It is to be understood however that the support could have another shape and that the perpendicularity is not mandatory for the invention to work. For example, in another embodiment, the supports could be a pair of plates. The resilient means 120 are springs in this particular embodiment.

It is to be noted that, in the preferred embodiment, the device described is symmetrical. In some of the Figures, only one side of the device is shown and the description is made to the singular only for purpose of clarity of the text. However, in other embodiments, the device could comprise elements or parts on only one side and still be within the scope of the invention. For example, even if there were only one spring on one side, the device would still work as described herein.

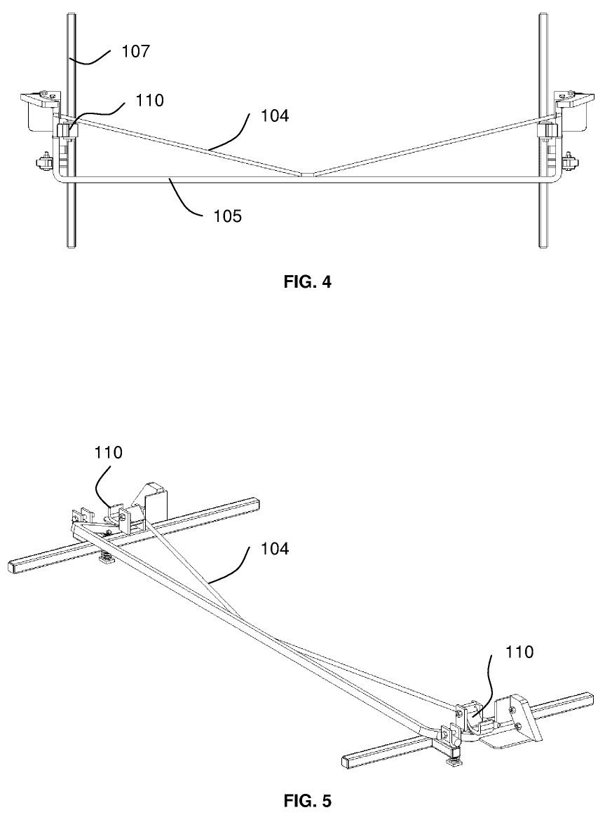

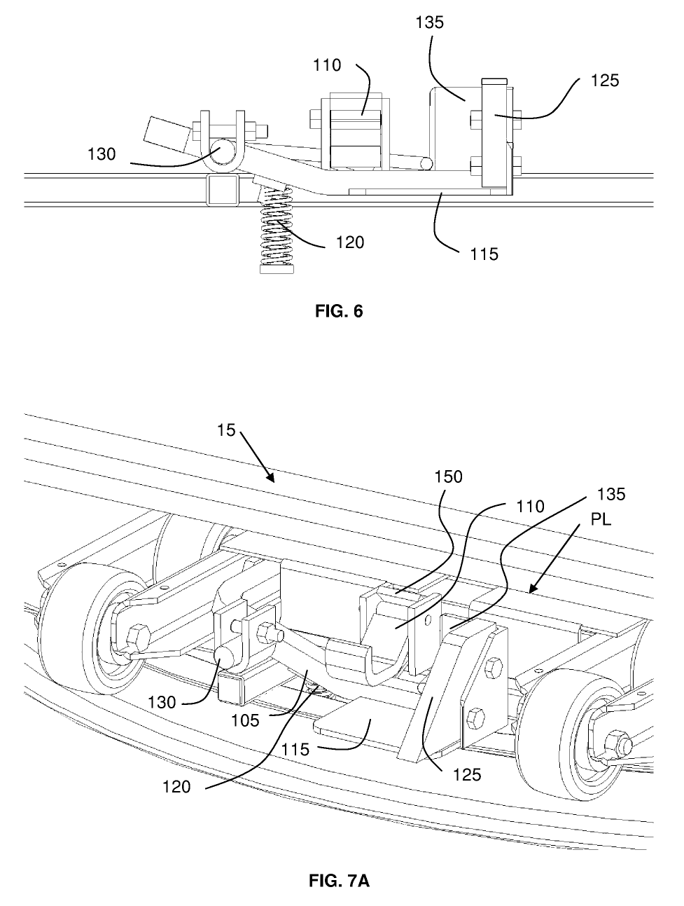

The engaged position means that the hooks 110 and the stop plates 135 are upwardly oriented (as in FIGS. 1 to 4). A hook actuator 114, an extension in this particular embodiment, maintains the hook 110 in this position. The unengaged position means that the hooks 110 and the stop plates 135 are downwardly oriented (as in FIGS. 5 to 8). At both ends of the frame 105 are located ramp parts 125, pedals 115 and stop plates 135. The stop plates 135 limit the lateral movement of the container when the device is in an engaged position. The pedals 115 allow a user to disengage the device by applying pressure on one of the pedal 115 with a foot.

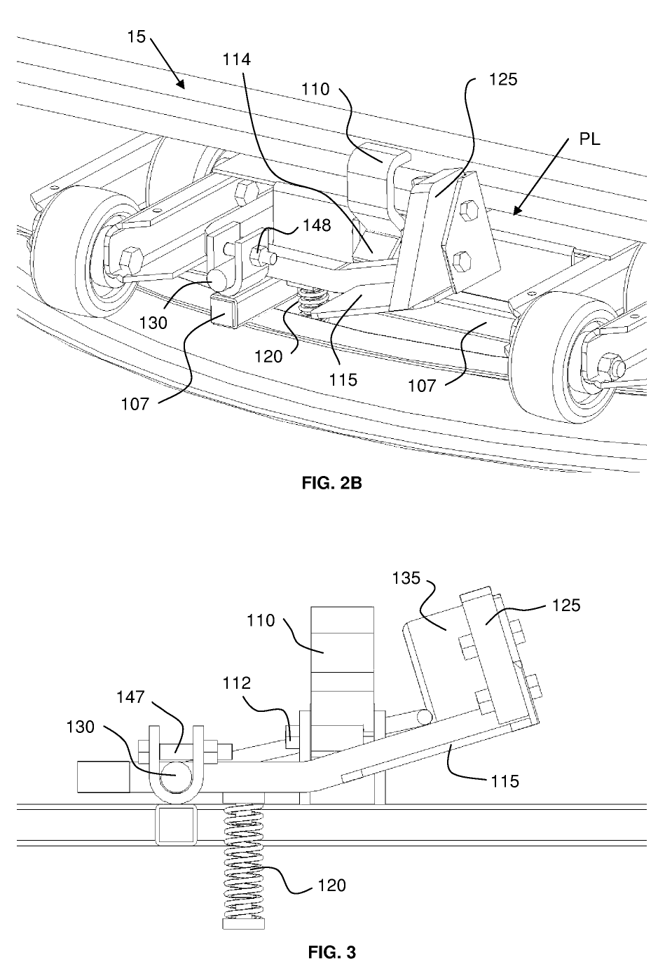

Referring to FIG. 2a and FIG. 2b, the frame 105 comprises a pair of pivots 130. The support 107 comprises means to cooperate with the pivots 130, in this case a u-shaped receiving member 140 comprising an opening 145. The receiving member 140 is connected to the support 107, using means known in the art to connect metal parts such as welding, and the receiving member 140 adapted to receive the pivots 130. The pivot 130 is inserted into the opening 145 of the receiving member 140. The frame 105 is free to rotate along the longitudinal axis 131 of both pivots 130. The pivot 130 is secured into the opening 145 with a rod or with a bolt 147 and a nut 148.

The hook 110 is pivotally connected to the support 107 through a hook member 111 and a hook pin 112. The hook 110 is maintained in an engaged position under the action of the hook actuator 114, in this preferred embodiment. The hook actuator extends from the frame 105.

The spring 120 is connected between the frame 105 and a portion of the cargo transporting vehicle, preferably to the turntable (not shown). The spring 120 may be in an uncompressed state (corresponding to the engaged position of the device) or in a compressed state (corresponding to the unengaged position of the device), under the weight of a container, or actuation of a pedal.

The force of the spring 120 maintains the frame 105 in an upward position (engaged position of the device). The spring 120 is preferably completely compressed by the weight of an empty container 15.

The arrow indicated as “PL” indicates the platform level, which the surface on which a container 15 rests. It is possible to see in FIGS. 2a and 2b that the hook 110 and the stop plate 135 are above the level of the platform and that the lateral movement of the container 15 is limited by the stop plate 135.

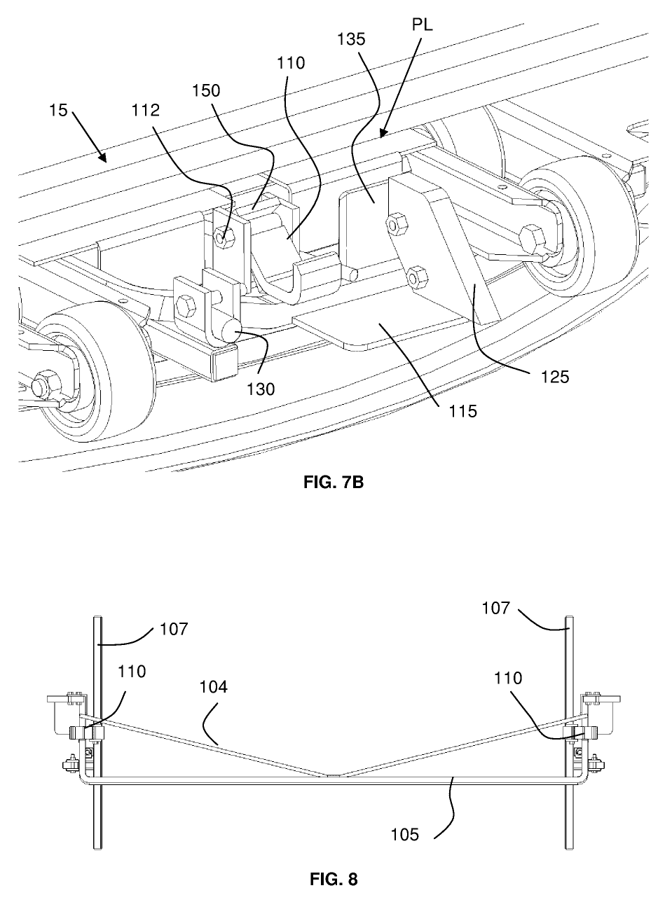

In FIGS. 7a and 7b, the device is in an unengaged position. Under the weight of the container 15, or by pressing on a pedal 115, the frame 105 rotates along the axis (131 in FIG. 1) of the pivot 130 and the stop plate 135 is now under the level “PL” of the platform. Since the hook actuator 114 has moved downwardly, the hook 110 pivots in its unengaged position.

In FIGS. 7a and 7b, it is possible to see the limiting member 150, preventing the hook to pivot toward the inside of the cargo transporting vehicle. The extreme positions of the hooks are thus the engaged position as shown in FIGS. 2a and 2b and the unengaged position as shown in FIGS. 7a and 7b.

The V-shaped element 104 shown in FIGS. 1, 4, 5 and 8 is a reinforcing rod that is not obligatory. It is to be noted that another structure could be used to reinforce the device of the present invention without departing from the scope of the present invention.

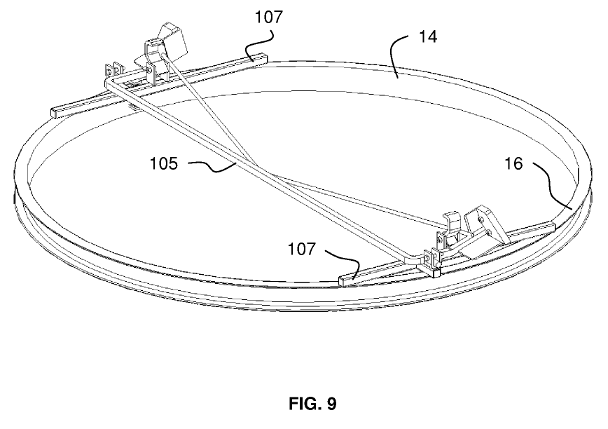

FIG. 9 shows the securing device for container installed on a turntable ring of a cargo transporting vehicle. The supports 107 are connected to the turntable 14, on the surface 16. They may be connected with fastening means or with welding, for example, but any other suitable means could be used.

The containers may arrive on the platform either in the direction of the arrows A or B shown in FIG. 1. For the purpose of this example, suppose that a container comes along arrow A. The ramp parts 125 are the first elements reached by an oncoming container 15. The slope of the ramp part 125 and the material chosen (low friction coefficient) allow the container to slide on it and subsequently on the platform. By pressing on the ramp parts 125, the frame transmits the downward movement to the springs 120.

While the springs 120 are compressed, the frame 105 rotates along the axis 131 and the ramp parts 125 move under the level of the platform. The hook actuators 114 are connected to the frame 105, and thus follow the same movement as the frame 105. This causes the hooks to pivot to their unengaged position.

When the spring 120 is fully compressed, the hooks 110 and stops plates 135 are at their lowest level and the container is free to pass over the hooks 110 and stop plate 135, as shown in FIGS. 5 to 8.

When the back side of the container passes over the ramp part 125 that was engaged by the front side of the container, the springs 120 regain their uncompressed state since there is no more weight applied on the ramp part 125 by the container. With no pressure applied by a container or otherwise, the spring 120 pushes upwardly the frame 105 that in turn pushes against the hook actuators 114 and then against the hooks 110. The hooks 110 recover the position shown in FIG. 2 and engages the edge 12 of the container located on the platform, limiting its vertical movement. The stops plates 135 are also in the engaged position and limit the lateral movement of the container.

The distance between the two stop plates 135 is preferably a little larger than the size of the containers to be transported by the platform.

It is to be noted that the device shown in the present document is not limited to a particular size of container. Indeed, a variety of sizes may be available, corresponding to the dimensions of the containers used.

The ramp part may be made with a material having a low friction coefficient such as metal or polymeric material, and preferably with polyethylene. The other parts are preferably made from a material having a resistance to impacts, to outdoors climate and to water. In the present embodiment these part are made from steel.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1) An automatic securing device for cargo containers to be used with a cargo transporting platform, said device comprising:
a) a support;
b) a frame having a rotational axis, said frame being rotatably connected to said support;
c) a pair of hooks rotatably connected to said support, said hooks adapted to vertically restrain said container, said hooks being displaceable between an engaged position and an unengaged position;
d) a pair of stop plates substantially vertically connected to said frame, said stop plates adapted to laterally restrain said container, said stop plates being displaceable between an engaged position and an unengaged position;
e) means to resiliently upwardly bias said hooks and said stop plates to their engaged positions; and
f) ramp means engageable with said container to cause said hooks and said stop plates to move downwardly to their unengaged position.

2) The device as claimed in claim 1, further comprising a limiting member to prevent said hook to pivot toward the inside of said platform.

3) The device as claimed in claim 1, further comprising a hook actuator extending from said frame, said hook actuator adapted to push on said hook.

4) The device as claimed in claim 1, further comprising a pedal connected to said frame.

5) The device as claimed in claim 1, further comprising a pedal connected to said ramp means.

6) The device as claimed in claim 1, wherein said support is a pair of T-shaped members.

7) The device as claimed in claim 1, further comprising a reinforcing structure connected to said frame.

8) The device as claimed in claim 1, wherein said frame is U-shaped.

9) The device as claimed in claim 1, wherein said resilient means are springs.

10) The device as claimed in claim 1, wherein said ramp means have a slope allowing said container to slide on said platform when said container is pushed thereon.

11) The device as claimed in claim 10, wherein when said container is pushed on said platform, said ramp means compress said resilient means, causing said hooks and said stop plates to move from the engaged position to the unengaged position.
